(19) United States
(12) Patent Application Publication
(10) Pub. No.: US 2011/0218820 A1
(43) Pub. Date: Sep. 8, 2011

(54) Displaying and Manipulating Brain Function Data Including Filtering of Annotations

(76) Inventors: David M. Himes, Seattle, WA (US); Michael A. Katz, Seattle, WA (US)

(21) Appl. No.: 12/716,147

(22) Filed: Mar. 2, 2010

(51) Int. Cl. G06Q 50/00; G06F 17/00

(52) U.S. Cl. 705/3; 715/232

(57) ABSTRACT

A user is enabled to request a visual review of a plurality of subsets of aggregate brain activity data, and the data contained in each subset are transformed into a visual display presented to the user. Significantly, rather than requiring the user to separately request a visual display of each selected subset, a visual display for each different subset is automatically sequentially displayed, based upon a single user request. This sequential display is particularly useful where the data from each subset cannot be readily displayed simultaneously. Thus, if twenty subsets are selected by the user from the aggregate brain activity data, then twenty different visual displays will be selectively generated and sequentially displayed in response to a single user request. Such subsets can be defined by annotations, where such annotations are defined by a patient input, an automated review, or an expert review.

### BACKGROUND OF THE INVENTION

Epilepsy is a disorder of the brain characterized by chronic, recurring seizures. Seizures are a result of uncontrolled discharges of electrical activity in the brain. A seizure typically manifests itself as a sudden, involuntary, disruptive (and often destructive) sensory, motor, and cognitive phenomenon. Seizures are frequently associated with physical harm to the body (e.g., tongue biting and limb breakage), a complete loss of consciousness, and incontinence.

A single seizure typically does not cause significant morbidity or mortality, but severe or recurring seizures (epilepsy) result in major medical, social, and economic consequences. Epilepsy is most often diagnosed in children and young adults, making the long-term medical and societal burden severe for this population of patients. People with uncontrolled epilepsy are often significantly limited in their ability to work in many industries, and usually cannot legally drive an automobile. In an uncommon, but potentially lethal form of seizure called status epilepticus, the seizure can continue for more than 30 minutes. This continuous seizure activity may lead to permanent brain damage and can be lethal if untreated.

There is no known cure for epilepsy, and the primary treatment for epileptic patients is the administration of one or more anti-epileptic drugs. A major challenge for physicians treating epileptic patients is gaining a clear view of the effect of a medication or incremental changes in medications. Presently, the standard metric for determining the efficacy of a medication is for the patient (or the patient's caregiver) to keep a diary of seizure activity. However, it is well recognized that such self reporting is often of poor quality because patients often do not realize when they have had a seizure, or fail to accurately record seizures. Patients often have sub-clinical seizures, in which the brain experiences a seizure, but the seizure does not manifest itself clinically, and the patient may not even recognize that the seizure has occurred.

An alternative to self reporting of seizure activity is to collect brain activity data that can be medically reviewed. In the past, such data have been collected in an epilepsy monitoring unit, where the patient undergoes continuous video-EEG monitoring in an attempt to capture ictal brain activity (seizure activity) and interictal brain activity (non-seizure activity). This data can then be viewed using existing EEG viewing software, such as applications provided by the Persyst Development Corporation of Prescott, Ariz.

Significantly, brain activity data (at least from the standpoint of epilepsy) can be characterized as including a relatively large amount of irrelevant data and a relatively small amount of important data; epileptic seizures are relatively rare, so that brain activity data collected during such an epileptic seizure represent a very small subset of the total brain activity data likely to be collected. Reviewing brain activity data is a tedious yet important task, particularly as clinicians are still attempting to determine patterns in such data that may be used as predictors of future seizures. For example, even an expert reviewer may require hours to complete the manual review of brain activity data collected over several days. Accordingly, it would be desirable to develop a more efficient approach to reviewing brain activity data that substantially reduces the time required.

### SUMMARY OF THE INVENTION

Disclosed herein are exemplary techniques for making the review of brain activity data more efficient. In one exemplary embodiment, a plurality of subsets of the aggregate brain activity data are selected, a user is enabled to request a visual review of the plurality of subsets, and the data contained in each subset are transformed into a visual display presented to the user. Significantly, rather than requiring the user to request a visual display of each selected subset individually by requiring keypress or other input device inputs to prompt the display of each subset, a visual display for each selected subset is automatically presented, one subset at a time in sequence, based upon a single user command. In other words, the selected subsets of the brain activity data are played in sequence and the segments of brain activity data between the selected subsets are omitted during playback. This sequential display may be particularly useful where the data from multiple subsets cannot be effectively displayed simultaneously. Thus, if twenty subsets are selected by the user from the aggregate brain activity data, then twenty different sequences of visual displays will be selectively generated and sequentially presented in response to a single user command.

In one embodiment, brain activity data are collected from a patient over an extended period of time. The brain activity data can be continuously collected from a patient over the course of several days, in order to acquire a representative data sample. The conventional approach is to collect brain activity data using implanted leads in a clinical setting over a limited period of time (e.g., over a period of several days). In some cases, it may be beneficial to collect brain activity data from a patient continuously over the course of months, or to perform such monitoring on an ongoing basis, as part of a patient's normal daily activity. There is hope that detailed study of this brain activity data collected from ambulatory patients may lead to the ability to predict when a patient might be most at risk for experiencing a seizure. Amassing and analyzing large amounts of such brain activity data may lead to developing predictive techniques for managing epilepsy. In a task that is in some ways analogous to collecting seismic data, it can be appreciated that the collection of brain activity data can occur continuously for relatively long periods of time. It should be recognized, however, that in various embodiments, the specific period of time for collecting data may vary, and the data may be collected with or without temporal gaps in the collected data. Where such large periods of data are collected, the review of numerous selected events within that set of data can be burdensome if the reviewer is forced to press a key or click a mouse in order to transition to each subsequent event. The automatic playback of multiple events and skipping of unselected segments of data can permit the reviewer to focus on the visual review of the data and/or use his or her hands for purposes other than navigating the data.

In an exemplary embodiment, the brain activity data are collected by a brain function sensor, which can be disposed externally or at a sub-dermal location. Commonly owned U.S. Patent Publication No. 2008/0027515, filed Jun. 21, 2007, the specification and drawings of which are specifically incorporated herein by reference, discloses a method and apparatus that can be used to collect brain activity data. It should be recognized, however, that such brain activity data can be collected using different methods and apparatus. In at least one embodiment, the brain activity data comprise sixteen (16) channels of data, but in other embodiments, there may be more or fewer channels of brain activity data collected.

In an exemplary embodiment, the brain activity data are stored in a digital format, enabling digital processors to be used to analyze the brain activity data. Alternatively, the brain activity data can be stored in analog format and digitized before analysis, although data collection techniques will more typically provide digital data.

The selected subsets of the brain activity data are referred to herein and in the claims that follow as “annotations.” Thus, an exemplary embodiment includes the step of selecting a plurality of different temporal segments from the brain activity data, with each different temporal segment being defined as a unique annotation, thereby defining a plurality of annotations.

Annotations can be selected using one or more of the following techniques, including selecting a temporal segment based on input from a patient from which the brain activity data are collected, selecting a temporal segment based on visual review of the brain activity data (e.g., by an epileptologist or neurologist), and selecting a temporal segment based on the presence of one or more predefined parameters in the temporal segment. In an exemplary embodiment, the process of scanning the brain activity data for temporal segments including a predefined parameter is automated. Predefined parameters include, but are not limited to, peak amplitude, and/or a measurement of how a particular data segment varies from previous data segments.

In at least one exemplary embodiment, the step of transforming the brain activity data corresponding to each annotation into a visual display includes the step of enabling a user to define an additional temporal segment of the brain activity data to be included in the visual display, before and/or after an annotation. Thus, the user is able to extend the temporal segments corresponding to an annotation.

In at least one exemplary embodiment, the step of transforming the brain activity data corresponding to each annotation into a visual display involves the step of using a funnel graphic to indicate the temporal relationship between the annotation currently being displayed and a larger temporal extent of the brain activity data that was collected.

In at least one exemplary embodiment, the step of transforming the brain activity data corresponding to each annotation into a visual display includes determining if any brain activity data have been collected between a first annotation and a second annotation, and if so, presenting a visual display of the second annotation after a visual display of the first annotation, without presenting a visual display of the brain activity data between the first annotation and the second annotation. Thus, in the sequential presentation of visual displays for each annotation, brain activity data collected between the different temporal segments defining an annotation are not displayed, enabling the user to automatically scroll through a relatively larger pool of brain activity data while viewing only a relatively small amount of brain activity data (each portion of the brain activity data being displayed corresponding to an annotation).

In at least one exemplary embodiment, the step of transforming the brain activity data corresponding to each annotation into a visual display includes the step of enabling a user to apply a filter to the plurality of annotations, such that the filter selectively controls which of the plurality of annotations will be transformed into a visual display to be sequentially presented. Similarly, a filter can be used to selectively control an order in which visual displays of the plurality of annotations will be sequentially presented. In one exemplary embodiment, a default order is employed that presents the visual displays for the annotations in a temporal order. However, where annotations can be separately classified, a filter can be used to allow the visual displays to be presented sequentially according to a classification, e.g., such that visual displays for annotations in a first class are presented before annotations in a second class.

In at least one exemplary embodiment, the step of transforming the brain activity data corresponding to each annotation into a visual display includes the step of simultaneously displaying a list of the plurality of selected annotations, along with the visual display of each annotation. In an exemplary embodiment, such a list will highlight the specific annotation for which a visual display is currently being presented.

In at least one exemplary embodiment, the step of simultaneously displaying the list of the plurality of annotations along with the visual display of each annotation includes the step of displaying a graphic proximate the list, the graphic indicating that the user has requested the sequential generation and presentation of a visual display for each annotation in the list. In an exemplary embodiment, the graphic proximate to the list is an arrow pointing to the list, and a checkbox that indicates that the sequential display is currently active.

Other aspects of the technique disclosed herein are directed to an apparatus and a system that implement functions generally consistent with the steps of the method discussed above.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### BRIEF DESCRIPTION OF THE DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a block diagram showing exemplary high level steps for implementing the automated presentation of visual displays for a plurality of annotations selected from a larger set of brain activity data, based on a single user request;

FIG. 2 is a block diagram providing exemplary techniques for selecting annotations from a larger set of brain activity data;

FIG. 3 is a block diagram illustrating an exemplary sequence of logical steps for implementing filtering annotations, so that less than all of the selected annotations are transformed into visual displays to be presented to a user;

FIG. 4 represents an exemplary menu to be displayed to a user once the user has decided to filter the annotations;

FIG. 5 represents an exemplary visual display of the brain activity data corresponding to a specific annotation, along with additional information relating to the brain activity data and other annotations;

FIG. 6 is an exemplary window for displaying a table of annotations for which visual displays will be automatically presented;

FIG. 7 is an exemplary window for controlling visual displays which will be automatically displayed based on a table of annotations; and

FIG. 8 is a block diagram illustrating an exemplary system used to implement the visual display technique disclosed herein.

### DETAILED DESCRIPTION OF THE INVENTION

Exemplary embodiments are illustrated in referenced Figures of the drawings. It is intended that the embodiments and Figures disclosed herein are to be considered illustrative rather than restrictive. No limitation on the scope of the technology or of the claims that follow is to be imputed to the examples shown in the drawings and discussed herein.

As noted above, techniques are disclosed herein for enabling a user to more efficiently review brain activity data. In an exemplary embodiment, the brain activity data results from tracking and collecting relatively small (i.e., microvolt) changes in electrical activity in the brain over time. The brain activity data may comprise electrical signals from the brain, including but not limited to electroencephalogram signals (sometimes referred to as “EEG”), intracranial EEG signals (sometimes referred to as “iEEG”), and electrocorticogram signals (sometimes referred to as “ECoG”). For convenience, these brain signals are collectively referred to herein as “EEG”. Once the brain activity data are collected, a plurality of temporal subsets of the aggregate brain activity data is selected (such subsets being referred to herein and in the claims that follow as annotations), a user is enabled to request a visual review of the plurality of subsets, and the data contained in each subset are transformed into a visual display presented to the user. Significantly, rather than requiring the user to separately request a visual display to be generated and presented for each subset that was selected, a visual display for each different subset is sequentially presented based upon a single user request. This sequential display is particularly useful where the data from all subsets cannot be effectively displayed simultaneously. Thus, if 20 subsets are selected from the aggregate brain activity data, then 20 different visual displays will be selectively generated and presented, all in response to a single user request.

### High Level Details of Annotation Filtering and Automated Annotation Display

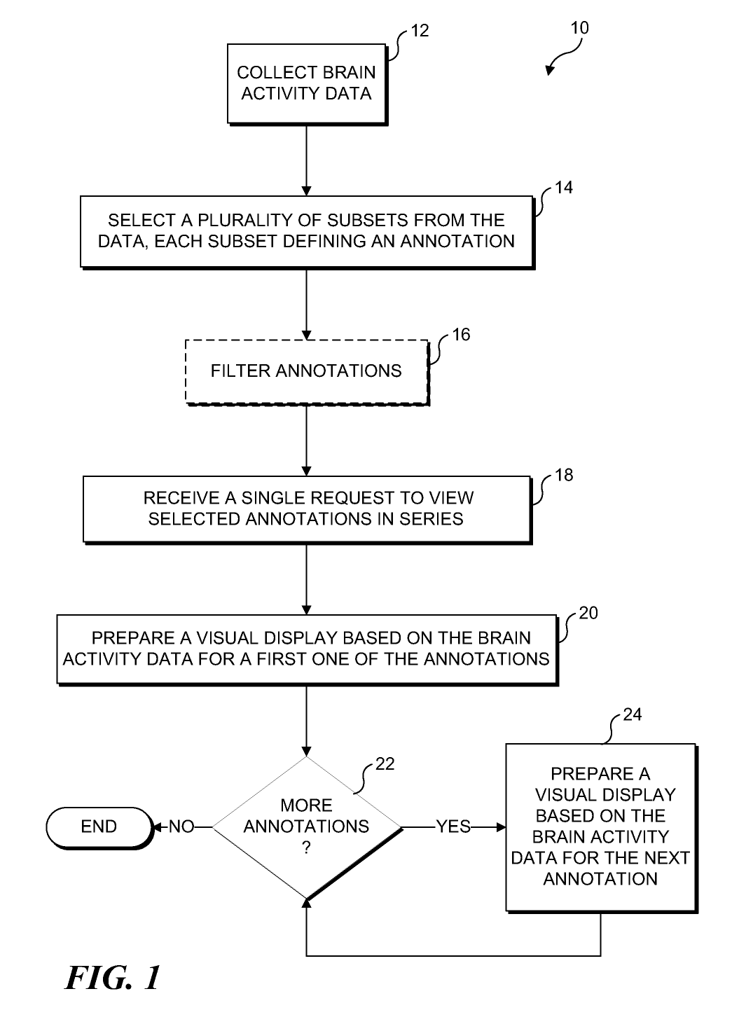

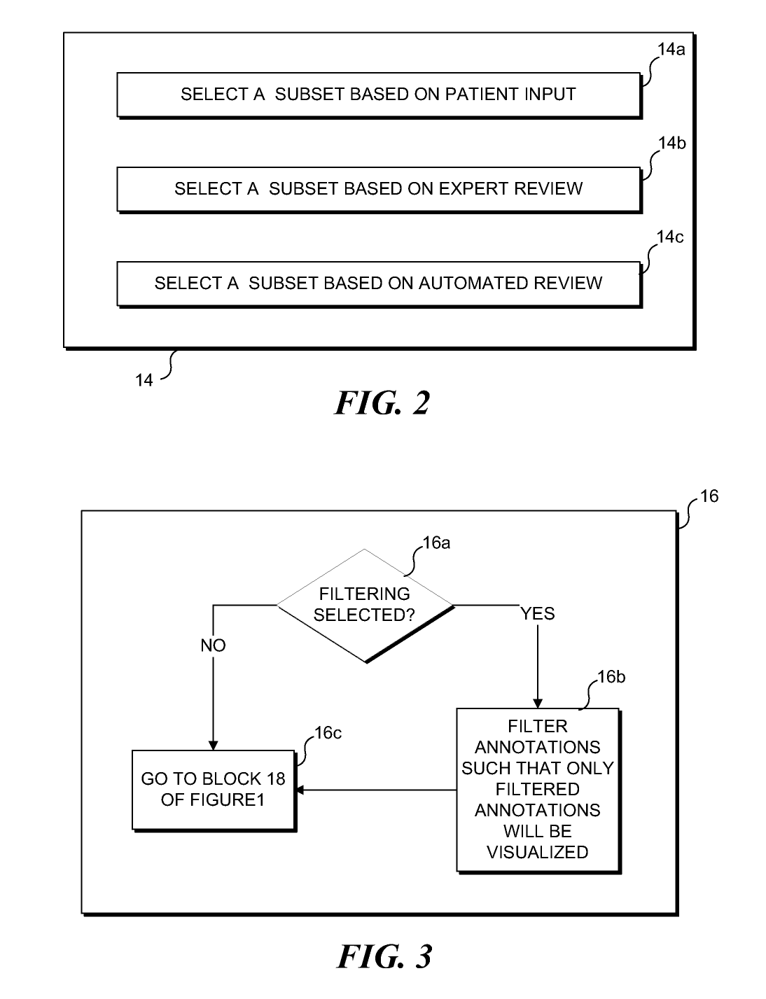

FIG. 1 is a block diagram showing exemplary high level steps 10 for implementing this automated display of a plurality of annotations selected from a larger set of brain activity data, based on a single user request. In a block 12, the brain activity data are collected. In an exemplary (but not limiting) embodiment, the brain activity data are collected for a plurality of different channels (16 channels representing an exemplary, but not limiting number). As noted above, in one exemplary embodiment, the brain activity data are stored in a digital format, enabling digital processors to be used to analyze the brain activity data; however, the brain activity data could instead be collected and stored in analog format and digitized before analysis.

In a block 14, a plurality of annotations (i.e., temporal subsets) are selected. FIG. 2, discussed below, provides exemplary techniques for selecting these annotations. Referring once again to FIG. 1, in an optional block 16, the annotations are filtered. FIG. 3, discussed below, illustrates exemplary techniques for filtering annotations. The optional filtering step recognizes that annotations themselves can be organized into different categories, and that filtering can be used to enable a user to control for which categories visual displays for annotations will be generated and presented, if less than all of the annotations are to be sequentially viewed.

In a block 18 of FIG. 1, the user is enabled to submit a single request to view a visual display of each annotation in turn (or of selected annotations in turn, if filtering is employed). This request may be made by the user by entering a keyboard command or using a pointing device to select a command on the user interface to initiate the visual displays. It should be recognized that other types of user input devices (other than keyboards and pointing devices) could be used to submit such a request. For example, a touch screen or a console with dedicated controls might alternatively be employed to provide the user input. Significantly, once the user has made a visual display request, a visual display for each selected annotation will be automatically generated and presented without the need for any additional user input. Thus, the user can focus on reviewing the visual displays, without being distracted by the need to perform repeated requests for visual displays, or by the need to hold down a key or other control to scroll through visual displays of the brain activity data corresponding to the temporal ranges of the selected annotations.

In a block 20, a processor transforms the stored data corresponding to the temporal range of the first annotation into a visual display that is presented to the user (i.e., displayed on a screen). The processor can be implemented using any of a variety of well-known techniques, such as a dedicated hardware processor (such as an application-specific integrated circuit or ASIC) or as a software-based processor (i.e., a computing device including a processor that executes machine instructions stored in a memory to carry out the functions that generate each visual display). It should be recognized that the brain activity data is collected and stored as an electrical signal, and as such is not suitable for being visually reviewed until the electrical signal is used to generate a visual display that can be presented to a user. Thus, the brain activity data is transformed from one format (an electrical signal) to a different format (a visual display).

As used herein, the term visual display refers to the display of a temporal segment of brain activity data. For example, the brain activity data may comprise sixteen channels of EEG signals, so the visual display of one temporal segment of brain activity data may include sixteen unique waveforms which scroll through a window in the user interface at a rate that may be selected by the user. Accordingly, the visual display for each annotation may include, e.g., hundreds of unique screen images that scroll through the window.

In a decision block 22, the processor determines if there are additional annotations for which visual displays need to be generated. If so, a visual display for the next annotation is generated and presented in a block 24, and the sequence of logical steps then returns to decision block 22. It should be noted that in at least one exemplary embodiment, by default, the annotations are sorted according to their temporal location in the brain activity data (such that an annotation corresponding to brain activity data collected at an earlier time will be transformed into a visual display before an annotation corresponding to brain activity data collected at a later time). Also, it should be recognized that the order in which visual displays of the annotations are sequentially generated and presented can be controlled differently, if desired. For example, visual displays for annotations referring to brain activity collected at a later time can be generated and presented before annotations referring to brain activity collected at an earlier time. Furthermore, where annotations can be organized into different categories, such categories can be used to control the order in which the visual displays are presented.

If, in decision block 22, it is determined that no additional annotations remain, then the logical sequence of steps terminates, as indicated by the end block.

As noted above, in block 14 of FIG. 1, a plurality of annotations (i.e., temporal subsets) are selected. FIG. 2 is a block diagram providing exemplary techniques for selecting these annotations. As indicated by a block 14a, annotations (i.e., temporal segments selected from the larger set of brain activity data previously collected) can be defined based on input from a patient from which the brain activity data are collected. As indicated by a block 14b, annotations can be defined based on expert review of the brain activity data. As indicated by a block 14c, annotations can be defined based on the presence of one or more predefined parameters in that temporal segment. In an exemplary embodiment, the process of scanning the brain activity data for temporal segments including a predefined parameter is automated. Predefined parameters include, but are not limited to, peak amplitude as well as a measurement of how a particular data segment varies from previous data segments.

With respect to block 14a, patient input can be provided in a number of ways. A patient can maintain a record (written, audible, or otherwise) of times during the collection of brain activity data when the patient experienced a seizure or an anomalous event. That time record can then be used to define an annotation. The amount of data before and after a specific time to be included in such an annotation can be varied as desired. It should be noted that some brain activity data collection devices include a patient input control (i.e., a button or key) that can be actuated by a patient to define an annotation.

With respect to block 14b, annotations can be defined based on visual review of the brain function data, such as by a neurologist, epileptologist, or other expert. The term “expert” refers to a clinician, physician, or technician trained to review brain function data and to identity patterns indicative of a seizure. Such annotations can be generated whenever an expert reviews all or part of the brain activity data that have been collected and determines that some segment of that brain activity data should be defined as an annotation. In at least one exemplary (but not limiting) embodiment, the expert can categorize the annotation being defined. For example, the expert can categorize an annotation as a definitive seizure, a possible seizure, or an anomalous event that does not appear to be a seizure.

Other annotations may also be used to identify different types of events, such as a CCS, UCS, CES, or NCS. A correlated clinical seizure (CCS) corresponds to a period of sustained rhythmic change (frequency and spatial evolution) in the electrocorticographic data which is clearly distinguished from background electrocorticographic data and interictal activity with evidence (e.g. seizure diary, audio recording) of clinical manifestation. An uncorrelated clinical seizure (UCS) corresponds to a period during which there is evidence of clinical manifestation of a seizure (e.g., seizure diary entry, audio recording) without a sustained rhythmic change (frequency and spatial evolution) in the electrocorticographic data which is clearly distinguished from background electrocorticographic data and interictal activity. A clinical equivalent seizure (CES) corresponds to a period of sustained rhythmic change (frequency and spatial evolution) in the electrocorticographic data which is clearly distinguished from background electrocorticographic data and interictal activity that has the same magnitude, propagation, and/or spread within 30 seconds of onset as a previously annotated correlated clinical seizure without evidence of clinical manifestation (e.g. seizure diary, audio recording). This classification is intended to capture those events that were likely associated with a clinical manifestation, but go unreported by the patient. A non-clinical seizure (NCS) corresponds to a period of sustained rhythmic change (frequency and spatial evolution) in the electrocorticographic data which is clearly distinguished from background electrocorticographic data and interictal activity without evidence of clinical manifestation (e.g. seizure diary, audio recording) that has a different magnitude, propagation, and/or spread within 30 seconds of onset than all previously annotated correlated clinical seizures. Electrodecremental events, brief bursts of spikes, and rhythmic bursting that do not evolve in a regular progression of frequency and amplitude are not considered to be a non-clinical seizure.

The expert may also provide a patient diary annotation indicating that the patient reported an event, but this event is separate from any corresponding seizure annotation that may be found. In some cases, when the patient notes a seizure in a diary, the expert will visually review the brain activity data for a seizure at or around that time (e.g., reviewing up to an hour behind and an hour ahead of the reported seizure). If the expert identifies a seizure in the brain activity data, he or she will create a CCS seizure annotation that runs from the start of the seizure to the end of the seizure, according to the waveforms in the data. If the expert does not identify seizure activity in the data, the expert may or may not create a UCS seizure annotation at the time noted by the patient. The expert may create the UCS seizure annotation with zero duration so as to store a marker for that location.

Finally, the expert may insert an arbitrary comment associated with a certain period of time. In at least one embodiment, a software application implementing the concepts disclosed herein is configured to enable expert users to define additional categories of annotations.

As the expert is reviewing the brain activity data to define an annotation, the expert can review the entirety of the collected brain activity data, or only selected portions of the brain activity data. For example, the expert might only review annotations defined by patient input (i.e., block 14a) or automated review (i.e., block 14c). While those segments are already annotations, the expert reviewer can change the category of the annotation or create additional seizure annotations corresponding to the same event. For example, an expert might review three annotations defined by patient input, and five annotations defined by an automated review, and determine that one of each type of annotation represents a definitive seizure, and one of each type of annotation represents a possible seizure. Additional annotations corresponding to definitive seizures and possible seizures (as opposed to annotations categorized as being defined by patient input or by an automated review) may be added to supplement the existing annotations or in other embodiments to replace the original annotations. The balance of the annotations reviewed by the expert can maintain their original categorization, can be supplemented with additional annotations, or can be re-categorized as annotations that have been reviewed by an expert but not classified as a definitive seizure or possible seizure.

With respect to block 14c, in an exemplary embodiment, predefined parameters include, but are not limited to, peak amplitude as well as a measurement of how a particular data segment varies from previous data segments. In an exemplary embodiment, the algorithm for such an automated review is referred to as an Automated Seizure Annotation (ASA) algorithm, and annotations defined by such a review are categorized as ASAs.

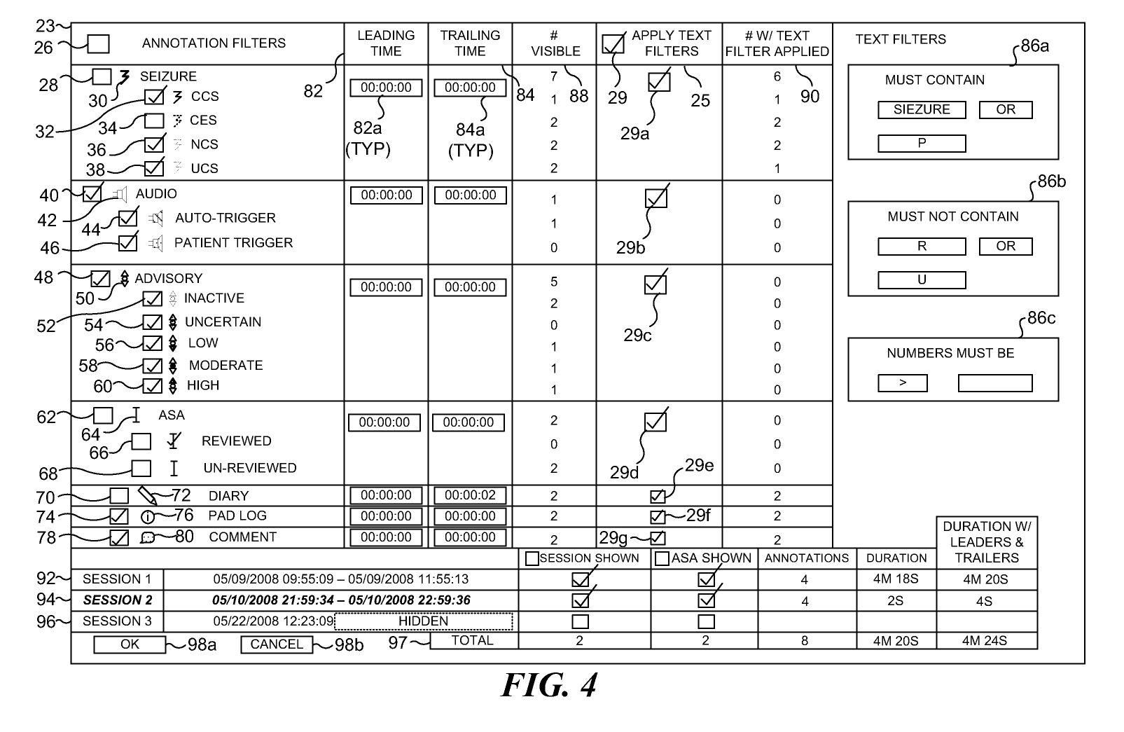

As noted above, in block 16 of FIG. 1, the annotations can be filtered, such that only a subset of all the annotations that have been defined are sequentially processed to provide visual displays to a user based upon a single request. FIG. 3 is a block diagram illustrating an exemplary sequence of logical steps for implementing such a filtering function. Referring to FIG. 3, in a decision block 16a, a determination is made as to whether a user has selected filtering. While many different user interfaces can be employed, in general, a user might select a filtering option presented in a dialog box or via a menu. FIG. 4 is an exemplary filtering menu that can be presented to a user after the option for filtering has been selected. As discussed in detail below, the exemplary menu of FIG. 4 enables a user to select from among a plurality of different filters to apply to the annotations. If in decision block 16a, filtering has been selected, a menu (such as that shown in FIG. 4) enables a user to selectively enable filters, and then in block 16b the selected filters are used to filter the annotations defined in block 14 of FIG. 1. Next, in step 16c, the first visual display of an annotation indicated in block 18 of FIG. 1 is implemented. If in decision block 16a filtering has not been selected (or if the procedure does not include the optional filtering step of block 16), block 18 continues with the plurality of annotations defined in block 14, unchanged.

FIG. 4 represents an exemplary menu to be displayed to a user once the user has selected to apply the optional filter to the previously defined annotations. In the exemplary menu, the user is presented with a plurality of filtering options. In broad terms, the user can select to filter the annotations based on category filters or text filters (or both). Category filters are selected using the checkboxes in column 23, while text filters are defined in boxes 86a, 86b, and 86c and are enabled using the checkboxes in column 25. The exemplary menu classifies annotations into the following seven different categories: seizure annotations, audio annotations, advisory annotations, automated annotations (i.e., ASAs), diary annotations, PAD log annotations, and comment annotations. Each of these different types of annotations can be separately selected using an appropriate checkbox.

Seizure annotations may represent time ranges that have undergone expert visual review and have been definitively classified as a seizure. If a user desires visual displays of seizure annotations to be generated and presented, the user can select a checkbox 28. A lightning bolt icon 30 is used to visually indicate that an annotation is classified as a seizure annotation. While icons are not required, the use of such icons enables information to be rapidly assimilated by a user. It should also be noted that the lighting bolt icon is exemplary, and other icons can instead be employed (this comment applies to each icon discussed herein). Note that the exemplary menu further classifies seizure annotations into four different subcategories: CCS seizure annotations, CES seizure annotations, NCS seizure annotations, and UCS seizure annotations. Each subcategory can be selected in the filter if the user checks an appropriate checkbox 32, 34, 36, and 38. The lighting bolt icon is modified for each different seizure type. While FIG. 4 indicates that the modification is directed to different line types, in an alternate embodiment, color, rather than line type, is used to differentiate the different seizure icons.

If a user desires visual displays of CCS seizure annotations to be generated and presented, the user will select checkbox 32. If a user desires visual displays of CES seizure annotations to be generated and presented, the user will select checkbox 34. If a user desires visual displays of NCS seizure annotations to be generated and presented, the user will select checkbox 36. If a user desires visual displays of UCS seizure annotations to be generated and presented, the user will select checkbox 38.

Audio annotations represent annotations that have been defined by an audible record. A brain activity data collection device may be equipped with a microphone. In some embodiments, the device is patient-triggered, so that the patient can activate the microphone and verbally describe what is being experienced at a particular time during the collection of brain activity data, or to simply indicate that something anomalous is happening, so that an expert can review the brain activity data collected at that particular time. Alternatively, the brain activity data collection device may be auto-triggered, such that the microphone is automatically activated by the device in response to detection of some event, such as if the device detects a seizure. If a user desires visual displays of audible annotations to be generated and presented, the user can select checkbox 40. A speaker icon 42 is used to visually indicate that an annotation is classified as an audible annotation. Each audible subcategory (patient and auto-triggered) can be selected using an appropriate checkbox. Thus, auto-triggered audible annotations are selected using a checkbox 44, and patient-triggered audible annotations are selected using a checkbox 46. The speaker icon is modified for each different seizure type. While FIG. 4 indicates that the modification is directed to different shading types, in an alternate embodiment, color, rather than shading, is used to differentiate the different seizure icons.

In some systems, the brain activity data collection device may provide seizure likelihood advisories, such as those described in U.S. Patent Publication No, 2008/0183096, filed Jan. 25, 2008, the disclosure of which is incorporated by reference herein in its entirety. In such a system, the data collection device may provide an advisory to the patient of the likelihood that the patient may experience a seizure in the near future. In one embodiment, the advisory may comprise the activation of one of three advisory lights on the data collection device (referred to as a Patient Advisory Device or PAD), which is worn by the patient like a pager. These advisory lights may be a red light indicating a high likelihood of seizure, a blue light indicating a low likelihood of seizure, and a white light indicating a moderate or unknown likelihood of seizure. The data collection device may record the current advisory that is illuminated during periods of brain activity recording. Advisory annotations reflect the state of the advisory. If a user desires visual displays of advisory annotations to be generated and presented, the user can select a checkbox 48. A geometric icon 50 (a circle disposed between the bases of two triangles) is used to visually indicate that an annotation is classified as an advisory annotation. Advisory annotations are further categorized into a plurality of subcategories, including inactive advisory annotations, uncertain advisory annotations, low-likelihood advisory annotations, moderate-likelihood advisory annotations, and high-likelihood advisory annotations. Each advisory subcategory can be selected by activating an appropriate checkbox, but these checkboxes will again be ignored if checkbox 28 and checkbox 48 are not selected. A different geometric icon is employed to represent each different seizure type. While FIG. 4 indicates that the modification is directed to different shading or line types, in an alternate exemplary embodiment, color, rather than shading, is used to differentiate the different advisory action icons.

If a user desires visual displays of inactive advisory annotations to be generated and presented, the user will select checkbox 52. Inactive advisory annotations represent periods of time during which no advisory is provided to the patient. In one exemplary embodiment, the geometric icon for an inactive advisory annotation is displayed using a gray icon.

If a user desires visual displays of uncertain advisory annotations to be generated and presented, the user will select checkbox 54. In an exemplary embodiment, the geometric icon for an uncertain advisory annotation is displayed using a yellow icon.

If a user desires visual displays of low-likelihood advisory annotations to be generated and presented, the user will select checkbox 56. In an exemplary embodiment, the geometric icon for a low-likelihood advisory annotation is displayed using a geometric icon whose lower triangle is highlighted.

If a user desires visual displays of moderate-likelihood advisory annotations to be generated and presented, the user will select checkbox 58. In an exemplary embodiment, the geometric icon for a moderate-likelihood advisory annotation is displayed using a geometric icon whose center circle is highlighted.

If a user desires visual displays of high-likelihood advisory annotations to be generated and presented, the user will select checkbox 60. In an exemplary embodiment, the geometric icon for a high-likelihood advisory annotation is displayed using a geometric icon whose upper triangle is highlighted.

ASAs represent annotations that have been defined by an automated review of the brain activity data. Generally this automated review is implemented after the brain activity data are collected and before the brain activity data are reviewed by an expert. The necessary processing elements could be added to the apparatus used to collect the brain activity data so that the automated review is performed during the collection process. Such a real-time automated review would be helpful if the automated review is able to identify brain activity data indicating that the patient is at risk of a seizure event, so that the patient might take an appropriate action (e.g., seek aid, take a dose of medication, or cease an activity such as driving that would place the patient at risk if a seizure occurred). If a user desires visual displays of automated annotations to be generated and presented, the user can select a checkbox 62. A bar icon 64 is used to visually indicate that an annotation is classified as an automated annotation. Automated annotations can be classified into two categories, including a category for annotations that are reviewed (by an expert) and a category for annotations that are un-reviewed. Each automated subcategory (reviewed and un-reviewed) can be selected using an appropriate checkbox. For example, reviewed automated annotations are selected using a checkbox 66, and un-reviewed automated annotations are selected using a checkbox 68, in this example. The bar icon used to indicate reviewed automated annotations includes a check mark adjacent to the bar.

Diary annotations represent written records from patients, either describing what the patient is experiencing at a particular time during the collection of brain activity data, or simply indicating that something anomalous is happening so that an expert can review the brain activity data collected at that particular time. If a user desires visual displays of diary annotations to be generated and presented, the user can select a checkbox 70. A pencil icon 72 is used to visually indicate that an annotation is classified as a diary annotation.

PAD log annotations represent annotations automatically generated by the data collection device upon occurrence of some event. If a user desires visual displays of PAD log annotations to be generated and presented, the user can select checkbox 74. A graphical icon 76 is used to visually indicate that an annotation is classified as a pad log annotation. In the embodiment illustrated in FIG. 4, only a single type of PAD log annotation is used for filtering purposes. In other embodiments, the PAD may issue multiple message types such as “critical error,” “error,” “warning,” “info,” or “debug,” and each of these message types may be separately filtered for visual display.

Comment annotations represent text comments added by a user for any purpose. If a user desires visual displays of comment annotations to be generated and presented, the user will select a checkbox 78. A balloon icon 80 is used to visually indicate that an annotation is classified as a comment annotation.

A column 82 (labeled leading time) includes a plurality of dialog boxes 82a, including a time display in an hours, minutes, and seconds format (i.e., 00:00:00) that can be manipulated by the user to select a desired amount of time to be added to the beginning of the annotation (annotations are temporal segments of the brain activity data, thus, dialog boxes 82a enable a user to add more brain activity data to an annotation by making the annotation start earlier in the brain activity data by a selected amount).

A column 84 (labeled trailing time) similarly includes a plurality of text boxes 84a, which can be manipulated by the user to select a desired amount of time to be added to the end of the annotation. It should be noted that, for annotations with subcategories (e.g., seizure annotations, audio annotations, advisory annotations, automated annotations, and PAD log annotations), only one time text box 82a or 84a is provided for each category of annotations and applies equally to all of its subcategories. If desired, such time text boxes could be provided for each subcategory.

A column 88 (labeled # visible) indicates the number of annotations of each category and subcategory that are included in the set of brain activity data being reviewed. For example, the set of brain activity data represented by the menu of FIG. 4 includes seven seizure annotations (one CCS seizure annotation, two CES seizure annotations, two NCS seizure annotations, and two UCS seizure annotations), one audio annotation (an auto-triggered audio annotation), five advisory annotations (two inactive advisory annotations, one low-likelihood advisory annotation, one moderate-likelihood advisory annotation, and one high-likelihood advisory annotation), two un-reviewed automated annotations, two diary annotations, two PAD log annotations, and two comment annotations. The user can use the checkboxes in column 23 discussed above to determine for which of those annotations a visual display will be provided in response to a single user request.

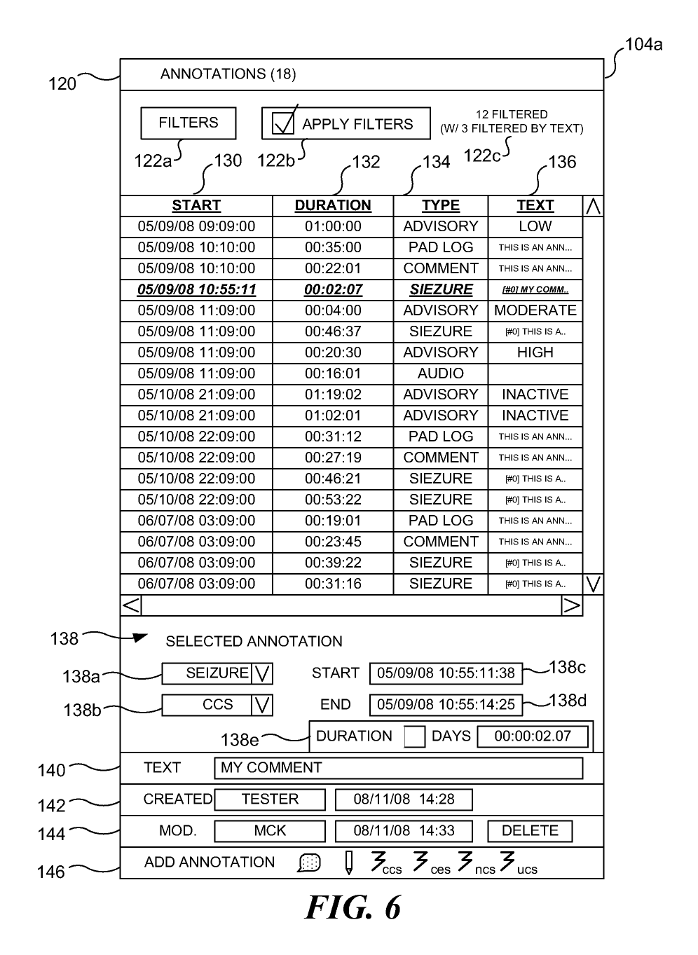

The inclusion of text filters recognizes that when an expert reviews an annotation, the expert can add notes to the annotation using textual descriptors, as well as alphanumeric abbreviations. A process for adding such text to an annotation is discussed below in connection with the description of FIG. 6. Checkbox 29 enables a user to use such text filters to control the annotations that will be transformed into a visual display for presentation to a user. Checkbox 29a enables a user to apply a text filter to seizure annotations, checkbox 29b enables a user to apply a text filter to audio annotations, checkbox 29c enables a user to apply a text filter to advisory annotations, checkbox 29d enables a user to apply a text filter to automated annotations (ASAs), checkbox 29e enables a user to apply a text filter to diary annotations, checkbox 29f enables a user to apply a text filter to PAD log annotations, and checkbox 29g enables a user to apply a text filter to comment annotations. It should be noted that only one text filter checkbox is provided for each category of annotations and applies equally to all of its subcategories. However, if desired, text filter checkboxes could be provided for each subcategory.

Dialog boxes 86a, 86b, and 86c enable a user to determine the textual or alphanumeric terms that are used by the text filter. For example, the menu of FIG. 4 indicates that the entire set of annotations will be filtered, such that only visual displays corresponding to the following set of annotations will be generated and presented. In the example shown, annotations including the descriptor text strings “seizure” or “P “, but not including either “R” or “U”. The number box searches for a numeric substring somewhere in the seizure's text string, and includes the seizure only if the numeric test passes. For example, the user may enter “100” in the box together with the “>” symbol. This would identify only seizures that contain a numeric substring that is greater than 100.

A column 90 (labeled # w/text filter applied) indicates the number of annotations of each category and subcategory that are included in the set of brain activity data being reviewed, when the text filter is applied. For example, when text filtering is applied as discussed above, the set of brain activity data represented by the menu of FIG. 4 includes six seizure annotations (one CCS seizure annotation, two CES seizure annotations, two NCS seizure annotations, and one UCS seizure annotation), no audio annotations, no advisory annotations, no automated annotations, two diary annotations, two PAD log annotations, and two comment annotations.

Rows 92, 94, and 96 (note that more or fewer rows may be used, or a scrolling menu of rows may be employed) enable a user to determine from which one of a plurality of different sets of brain activity data the annotations will be selected. In this exemplary embodiment, each row includes a label (i.e., Session 1, Session 2, or Session 3, where either fewer or more sessions can be displayed) for each set of brain activity data, the temporal extent of each session, a checkbox to enable the session to be selected or unselected, a checkbox to enable automated annotations to be selected or unselected, an indication of the number of annotations that are left after filtering, an aggregate total time for the annotations left after filtering, and an aggregate total time for the annotations if leading and trailing times are included. A row 97 provides a total number of sessions selected, a total number of automated annotations (ASAs) selected, the total number of annotations after filtering each session, an aggregate total time for the annotations left after filtering, and an aggregate total time for the annotations if leading and trailing times are included. The counts in columns 88 and 90 reflect annotations only from shown sessions, as defined by the check marks in the columns labeled “SESSION SHOWN” and “ASA SHOWN”. In the illustrated embodiment, two sessions are shown, Session 1 and Session 2. Column 88 provides the total number of visible annotations from these two sessions before text filtering is applied, and column 90 shows those totals after text filtering is applied.

Buttons 98a and 98b enable a user to accept the filter settings or navigate away from the menu without filtering.

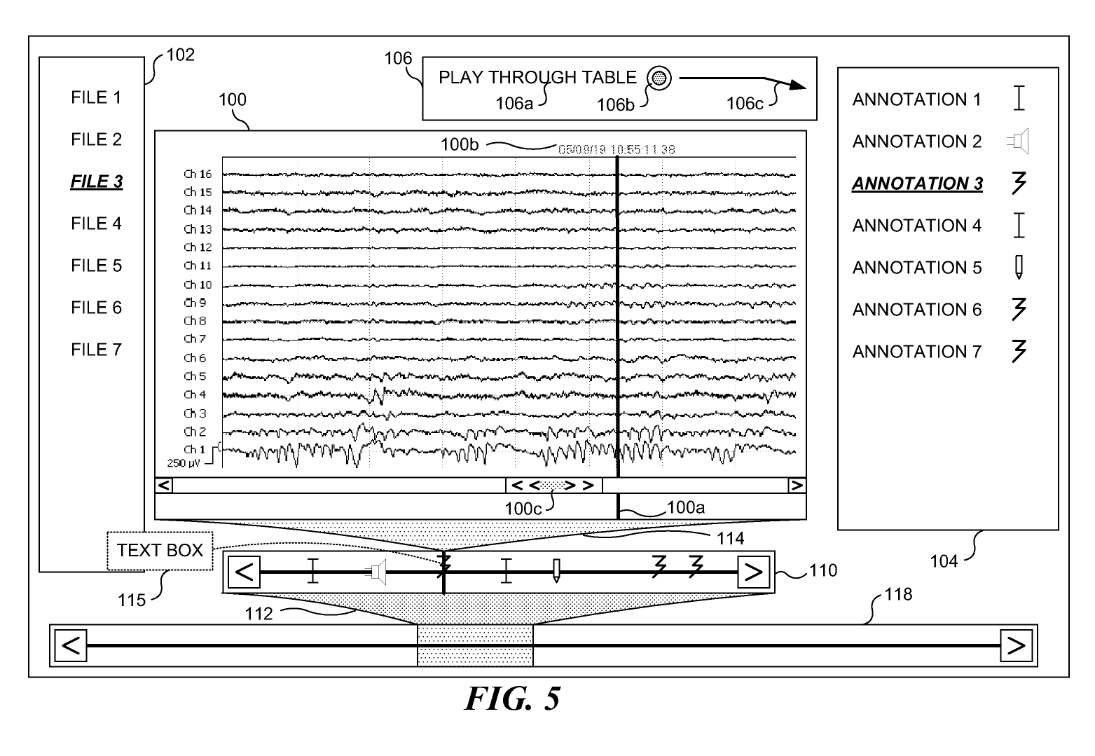

FIG. 5 represents an exemplary visual display of the brain activity data corresponding to a specific annotation, along with additional information relating to the brain activity data and other annotations. It should be recognized that while the additional information provides context, which is likely to be useful to the expert reviewer, the concept of providing sequentially generated and presented visual displays of brain function data corresponding to a plurality of annotations in response to a single user request can be implemented such that only the sequential visual displays are displayed, without displaying the additional contextual information.

Referring to FIG. 5, the current visual display is displayed in a window 100. The specific sizes and locations of windows in FIG. 5 is not critical; however, it is convenient to locate the visual display generally near a center of the display, since the visual display typically represents the most important content. As shown in FIG. 5, the brain function data include 16 channels that are individually displayed (with the temporal axis of the channels aligned), although as noted above, the specific number of channels is intended to be exemplary and not limiting. In this exemplary embodiment, a line 100a in window 100 sweeps across the window at a predefined speed, and label 100b indicates the temporal coordinate of the line.

A joystick scroll control 100c behaves much like a standard scroll bar, except it has a specialized joystick button (the double-ended arrow) instead of appearing as a typical scroll bar. The joystick button is used to scroll at variable speeds, depending on the distance the joystick button is dragged from the center position. In some embodiments, the joystick function is a manual scroll operation that is exclusive from the “Play through table” operation and therefore controls display of the unified data. In other embodiments, the joystick function provides control over scrolling through the filtered annotations.

If the annotation includes more brain activity data than can be displayed as a visual display in window 100 at one time, the visual display scrolls through window 100. If desired, user controls can be provided to enable the user to control the scrolling speed.

A window 102 enables the user to identify one or more of a plurality of different sets of brain activity data the visual display belongs. Window 102 indicates that seven different sets (or files, or sessions) of brain activity data are available, and that the visual display being displayed in window 100 corresponds to an annotation from file (session) 3. Window 102 can be organized as a hierarchical menu, including more or fewer sets of brain activity data.

A window 104 enables the user to identify one of a plurality of annotations as being visualized. Where annotation filtering has been employed, the table of window 104 can include each annotation remaining after filtering. Window 104 indicates that seven different annotations are included in file 3 (either in total or after filtering). The icons used to identify different types of annotations can be included in window 104 (and the shading/modifications discussed above can be used to indicate subcategories of annotations). Different descriptors can be used to refer to individual annotations, and such descriptors can be names or alphanumeric descriptors. FIG. 6, discussed in detail below, provides an exemplary embodiment of window 104 as implemented in a prototype software package providing the functions disclosed herein. It should be recognized that window 104 corresponds to a table of annotations.

A window 106 enables the user to selectively control the display of a visual display based on each annotation listed in the table of window 104. Window 106 includes a textual label 106a (i.e., “Play through table”), a checkbox 106b, and an arrow 106c pointing toward the table in window 104. The elements in window 106 have been selected to enable the user to play through the table in window 104 (i.e., to provide visual displays for each annotation in window 104 to be sequentially displayed in response to a single user request). When checkbox 106b is selected, the sequential visual display of the selected (or filtered) annotations is enabled. Arrow 106c draws the user's attention to the fact that the annotations being displayed represent playing through the table (since the user can also select a visual display for each annotation individually). Window 106 can include a button to activate the automatic sequential display of visual displays based on each selected annotation, so some other user input (such as a defined keystroke or series of keystrokes) can be used to initiate the sequential display. The brain activity data corresponding to portions of time that do not correspond to selected annotations are skipped and not displayed during play-through.

A window 110 and a window 118 each represent timeline boxes, enabling the user to visualize the temporal extent of a particular set of brain activity data, and the locations of annotations relative to that set of brain activity data. For example, window 118 represents the set of brain activity data referred to as FILE 3 in window 102. Depending on the scale of window 118 and a size of FILE 3, the entire timeline corresponding to FILE 3 may or may not be able to be displayed in window 118 at once (thus window 118 includes scroll buttons at each end of the timeline). If FILE 3 represents brain activity data collected over two hours, and window 118 is scaled to show a timeline of one hour, then the scroll buttons can be used to change the portion of FILE 3 currently being displayed in the timeline. While not specifically shown, it should be recognized that window 118 can include icons identifying timestamps at various locations and/or locations of annotations in the brain activity data, and a control can be provided to enable a user to change the scale of window 118.

Window 110 is also a timeline box for displaying a portion of the temporal extent of brain activity data; however, the scale of the timeline in window 110 represents a much shorter temporal extent of the set of brain activity data. A funnel graphic 112 indicates the relationship between the timelines in windows 110 and 118. Note that window 110 has been scaled such that all seven of the annotations from the table in window 104 can be seen in the timeline, enabling a user to quickly understand the temporal relationship between the different annotations. It must be recognized that depending on the number of annotations and the scale of the timeline in window 110, fewer than all of the annotations in window 104 may be simultaneously displayed in window 110 (thus, window 110 also includes scroll buttons at each end of the timeline). A funnel graphic 114 indicates the relationship between the annotation visual display in window 100 and the timeline in window 110. Note that funnel graphic 114 includes a line extending through Annotation 3 in window 110.

Once line 100a reaches the end of the visual display shown in window 100 (i.e., the last temporal portion of the brain activity data corresponding to Annotation 3), window 100 will display a visual display of the next annotation (i.e., Annotation 4), and funnel graphic 114 will move to the next annotation, skipping the portion of the timeline between Annotation 3 and Annotation 4 (such that the line portion of funnel graphic 114 will extend through Annotation 4 in window 110). An optional text box 115 can be displayed to provide details about the annotation currently being visualized in window 100. Information including but not limited to annotation category and subcategory, start time, end time, and duration can be displayed in such an optional text box. The specific location of such a text box is not critical. For example, the text box may be linked to the specific annotation, disposed adjacent to a specific annotation such that the user can readily determine to which annotation the text box refers, or may be positioned below window 104.

Window 104 in FIG. 5 shows a relatively simple table of annotations, with a particular annotation highlighted to enable a user to keep track of the annotation to which the visual display corresponds. FIG. 6 shows a window 104a defining a relatively more sophisticated table of annotations, implemented in a prototype software package that provides the functionality disclosed herein.

Referring to FIG. 6, a row 120 indicates that the table of annotations in window 104a includes 18 different annotations. A button 122a enables the user to access the filter menu shown in FIG. 4. A checkbox 122b must be selected to apply the filtering functions selected using the filter menu shown in FIG. 4. Text 122c informs the user that the filtering has filtered out twelve annotations, leaving eighteen annotations remaining. If the “Play through table” checkbox is selected, those eighteen annotations will be sequentially displayed after a user requests the visual display.

The table of annotations includes a plurality of columns, each providing information about the annotations. A column 130 provides the starting time for the segment of brain activity data corresponding to each annotation (note that the starting time will uniquely identify each annotation, because each annotation from the same set of brain activity data will have a different starting time). A column 132 provides the duration for the segment of brain activity data corresponding to each annotation. A column 134 provides the category of the annotation (while not shown, it should be understood that column 134 can also include the icon corresponding to the category (and subcategory) of the annotation, such that column 134 conveys to the user the specific classification of the annotation). A column 136 provides any text label that has been added to the annotation. Details for adding such a text label to an annotation are provided below. The fourth annotation in the table is highlighted in this example, indicating that the fourth annotation has been selected for display and editing, as shown in window 100 of FIG. 5.

A portion 138 of window 104a (which corresponds to text box 115 in FIG. 5) provides details about the highlighted annotation from the table of annotations (i.e., the annotations defined in columns 130, 132, 134, and 136). A drop-down menu 138a indicates the category of the annotation, while a menu 138b indicates the subcategory of the annotation. A text box 138c indicates a starting time of the annotation, while a text box 138d indicates an ending time of the annotation. A text box 138e indicates a duration of the annotation. A text box 140 enables a user to add or edit a text label associated with the annotation. A row 142 includes text boxes indicating by whom and when the annotation was generated, while a row 144 includes text boxes indicating by whom and when the annotation was most recently edited. A row 146 includes short-cut tools enabling an annotation to be added to the table of annotations.

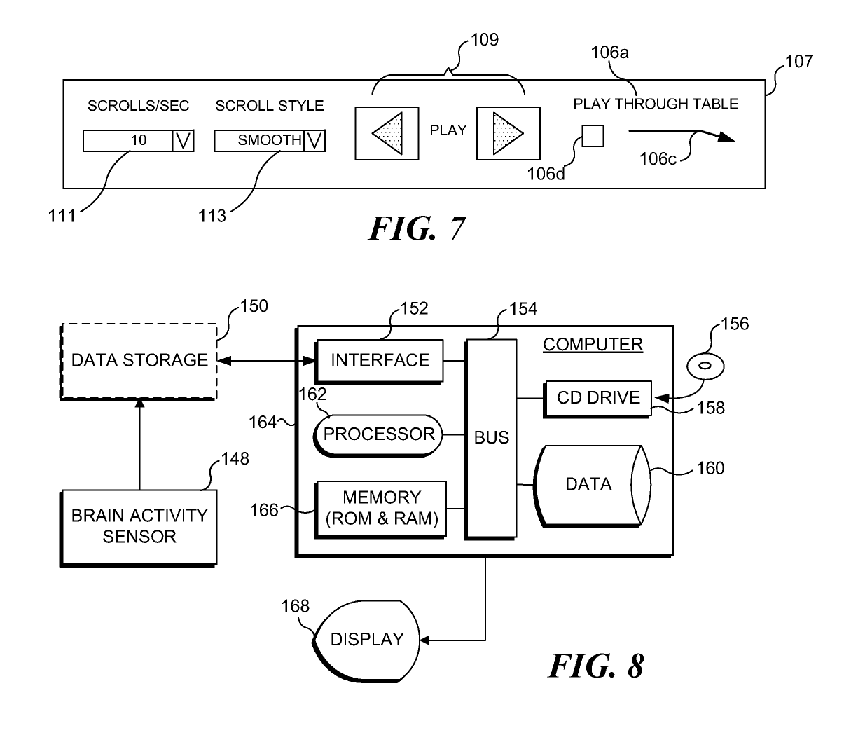

Window 106 in FIG. 5 enables the user to selectively control the display of a visual display based on each annotation listed in the table of window 104. FIG. 7 shows a window 107 defining a relatively more sophisticated window performing a similar function as implemented in a prototype software package implementing the concepts disclosed herein.

Referring to FIG. 7, window 107 enables the user to selectively control the display of a visual display based on each annotation listed in a table of annotations (such as shown in window 104 of FIG. 5 and window 104a in FIG. 6). Window 107 includes textual label 106a (i.e., “Play through table”), a checkbox 106d, and arrow 106c pointing toward the table of annotations. When checkbox 106d is selected, the sequential visual display of the annotations in the table is enabled, including the case where those annotations represent a user-defined subset of all available annotations as chosen in the filter dialog box. As noted above, arrow 106c draws the user's attention to the fact that the annotations being displayed are using the “play through table” function (since the user can alternatively opt to play through all of the data in full). A control 109 includes arrow buttons that can be used to selectively control the direction of automated play through the data, which as a result controls the order in which the listed annotations are shown, in the case that “Play through table” is checked. If the left pointing button is selected, the table is played through from bottom to top. If the right pointing button is selected, the table is played through from top to bottom. A control 113 enables a user to control the type of scrolling using a pull down menu, and a control 111 enables a user to control the speed of scrolling using a pull down menu.

In the embodiments described above, the system is configured to play through the table of annotations in chronological order, either forward or backward. In other embodiments, it may be desirable for the annotations to be played in a different order out of temporal sequence. For example, it might be desirable to play through the most likely or most severe seizures first, and then proceed to displaying the less likely or less severe seizures next. Other variations are possible.

Incorporation of the Inventive Concepts into Existing Software Tools

In an exemplary (but not limiting) embodiment, wherein the automatic sequential display of annotations (and filtering functionality, when implemented) is added to an existing product for reviewing brain activity data, the software code for running the automated review of a set of annotations is on top of the existing application code for displaying electroencephalography (EEG) graph data, displaying annotations in a timeline corresponding to the times on the graph, automatically scrolling through the “timeline” of all EEG data and annotations, listing annotations in a table, and storing the set of annotations persistently in a database.

In regard to this existing framework, the code for running the automated view of a set of annotations operates in an exemplary fashion, as follows: (a) The user clicks to position the time cursor at a given time within the overall EEG data time range. The user clicks a checkbox indicating that the “Play through table” mechanism should be used when playing through data. The user clicks a button indicating that automated review of selected annotations should begin in either the forward direction (one button) or the backward direction (another button). Note that the forward process is described below, and that the backward process is analogous, but runs backward in time, scanning each annotation from end to start. (b) The program searches in the given direction starting from the time cursor to find the next later (or the next earlier, for backward play) annotation time. (c) The program jumps the display to the start time (or end time) of the annotation that was found, or to a fixed time before the start time (or end time) of the annotation, if the user has specified a “leader” (or “trailer”) time for reviewing the given annotation. In one exemplary embodiment, this approach causes the EEG graph to show the graphs for the various EEG data channels for 10 seconds centered on the given time (i.e., 5 seconds before, and 5 seconds after). Similarly, the corresponding timeline or timelines show annotation data for the same time period. The table of annotations highlights the given annotation, which is shown as “selected” in the timeline(s), typically by drawing a brightly colored box around the annotation's duration line. (d) The display scrolls forward in time (the screen image scrolls off to the left to reveal new data coming in from the right) at a rate previously specified by the user. The user can specify both the “scrolls per second” (the number of frames that are drawn per second, where each frame is shifted in time compared to the preceding frame), and the “screens per scroll” (the fraction of the screen width that scrolls each frame—typically 0.1 screen for a smooth scroll effect, or 1.0 screen for a non-overlapping scroll). (e) The display continues to scroll forward until the selected annotation scrolls completely off the left edge of the screen (that is, until the annotation has passed off the left edge of the screen, as well as any further time required for the additional EEG data corresponding to the user-specified “trailer” time, if any, to pass off the left edge of the screen). At this point, the program again searches the set of annotations for the next highest starting time to continue on displaying the next annotation. If there is no next annotation to be reviewed chronologically, the program stops the scrolling and indicates to the user that display of the last annotation has been completed.

Typically, the user is reviewing annotations from one or more sessions (data sets) of EEG data within a large collection of EEG data sets including many (possibly hundreds or thousands) of sessions. The user typically marks a small number of sessions to be reviewed for any given use of the automated review function. Thus, when referring the last annotation in the set chronologically, the set refers to the last annotation of the selected sessions.

### Exemplary System for Implementing Automated Annotation Display Technique

FIG. 7 schematically illustrates an exemplary system suitable for implementing the automated sequential display based on visual displays generated using a selected group of annotations, as well as the annotation filtering concept discussed above. The system includes a brain activity sensor 148 configured to collect brain activity data from a patient. The brain activity data can be stored in a data storage device 150 (generally a digital memory, although if the brain activity data are collected in analog form, then an analog signal can be stored in the memory storage device). It should be recognized that the brain activity data could be conveyed directly from the data collection device to a computer 164, however, storage in device 150 is likely to be more convenient. It will be understood that data storage device 150 can be implemented as a non-volatile memory coupled to computer 164 via a network, such that one or more other network interface devices (not shown) may be disposed between the data storage device 150 and computer 164 to facilitate communicating the data between the data storage device and the computer.

Computer 164 is configured to process the brain activity data, to enable the automated sequential display based on visual displays generated using a selected group of annotations, as well as the annotation filtering concept (when implemented). Computer 164 may be a generally conventional personal computer (PC) or a dedicated controller specifically intended for implementing the functions described above. Although not shown, brain activity sensor 148 comprises a sensor and an interface enabling the collected data to be conveyed to another device for processing or storage. Such data collection devices are well known to those of ordinary skill. Accordingly, details of the brain activity sensor need not be, and are not, specifically illustrated or discussed herein.

Computer 164 is coupled to a display 168, which is used for sequentially displaying visual displays generated using annotation data, as well as for enabling a user to selectively apply the filtering techniques discussed above to a set of annotations, to enable visual display of less than the entire set of annotations. Included within computer 164 is a processor 162. A memory 166 (comprising both read-only memory (ROM) and random-access memory (RAM)), a non-volatile storage 160 (such as a hard drive or other non-volatile data storage device) for storage of data, digital (or analog) signals, and software programs, an interface 152, and an optical drive 158 are coupled to processor 162 through a bus 154. Optical drive 158 can read a compact disk (CD) 156 (or other optical storage media, such as a digital video disk (DVD)) on which machine instructions for implementing the present novel technique, as well as other software modules and programs are stored so that they may be executed by processor 162 in computer 164. The machine instructions are loaded into memory 166 before being executed by processor 162, causing the computer to carry out the steps for implementing the techniques disclosed above.

Although the concepts disclosed herein have been described in connection with the preferred form of practicing them and modifications thereto, those of ordinary skill in the art will understand that many other modifications can be made thereto within the scope of the claims that follow.

For example, in various embodiments described above, the data viewed by the user is brain activity data, such as EEG. In other embodiments, other types of physiological signals such as, e.g., brain temperature, blood flow in the brain, and concentration of anti-epileptic drugs (AEDs) in the brain, may be viewed.

In addition, in examples provided above, the user can select specific annotations or types of annotations via interaction with graphical elements in a graphical user interface (e.g., checkboxes, radio buttons, icons, text boxes). In other embodiments, the user may utilize other means for selecting the annotations for display. For example, the system may be configured to receive text-based queries, similar to SQL queries, and to select the annotations for display based on those queries. Any form of query language may be used to provide the desired level of complexity or querying function desired. Once the query is received and play-through activated, the system will proceed to generate the visual displays corresponding to the selected annotations.

Accordingly, it is not intended that the scope of these concepts in any way be limited by the above description, but instead be determined entirely by reference to the claims that follow.

What is claimed is:

1. A method for enabling a user to review brain activity data, comprising the steps of:
providing a plurality of annotations, each annotation including a temporal segment of brain activity collected from a patient;
filtering the plurality of annotations by enabling a user to select at least one criteria to be used to determine which of the plurality of annotations are to be included in a set of filtered annotations, the set of filtered annotations being a subset of the plurality of annotations;
enabling a user to request a visual review of the set of filtered annotations; and
transforming the brain activity data corresponding to each filtered annotation in the set of filtered annotations into a visual display that is presented to the user.

2. The method of claim 1, wherein the plurality of annotations includes annotations corresponding to a plurality of different categories, and wherein the step of enabling the user to select at least one criteria comprises the step of enabling the user to select at least one of the plurality of different categories, such that each annotation corresponding to a selected category is included in the set of filtered annotations.

3. The method of claim 1, wherein the plurality of annotations includes annotations that have descriptive parameters in addition to the brain activity data, and wherein the step of enabling the user to select at least one criteria comprises the step of enabling the user to select at least one descriptive parameter, such that each annotation corresponding to a selected descriptive parameter is included in the set of filtered annotations.

4. The method of claim 1, wherein the plurality of annotations include annotations corresponding to a plurality of different categories and annotations that have descriptive parameters in addition to brain activity data, and wherein the step of enabling the user to select at least one criteria comprises the step of enabling the user to select at least one criteria from a group of criteria consisting of:
the plurality of different categories, each different category comprising a different criteria; and
a plurality of descriptive parameters, each different descriptive parameter comprising a different criteria.

5. The method of claim 1, wherein the step of the step of enabling the user to select at least one criteria comprises the step of enabling the user to selectively include within the set of filtered annotations each annotation that is based on input provided by the patient from which the brain activity data are collected.

6. The method of claim 1, wherein the step of the step of enabling the user to select at least one criteria comprises the step of enabling the user to selectively include within the set of filtered annotations each annotation that is based on an expert review of the brain activity data.

7. The method of claim 1, wherein the step of the step of enabling the user to select at least one criteria comprises the step of enabling the user to selectively include within the set of filtered annotations each annotation that is based on an automated analysis of the digital brain activity data.

8. The method of claim 1, wherein the step of the step of enabling the user to select at least one criteria comprises the step of enabling the user to selectively include within the set of filtered annotations each annotation that corresponds to a seizure.

9. The method of claim 1, wherein the step of the step of enabling the user to select at least one criteria comprises the step of enabling the user to selectively include within the set of filtered annotations each annotation that corresponds to a specific type of seizure.

10. The method of claim 1, wherein the step of the step of enabling the user to select at least one criteria comprises the step of enabling the user to select at least one annotation from a group of annotations consisting of:
any annotation that is based on patient input;
any annotation that corresponds to a seizure;
any annotation that corresponds to a specific type of seizure;
any annotation that is based on an automated review of the brain activity data; and
any annotation that includes a specific descriptive parameter.

11. The method of claim, 1, wherein the step of transforming the brain activity data corresponding to each filtered annotation in the set of filtered annotations into the visual display presented to the user comprises the step of generating and presenting a different visual display for each filtered annotation.

12. The method of claim 11, wherein the step of generating and presenting the different visual display for each filtered annotation comprises the step of utilizing a funnel graphic to indicate a temporal relationship between the annotation for which the visual display is currently being presented and a larger temporal extent of the brain activity data that were collected.

13. The method of claim 11, wherein the step of generating and presenting the different visual display for each filtered annotation comprises the step of sequentially generating the visual display for each filtered annotation.

14. The method of claim 13, further comprising the step of enabling a user to selectively control an order in which the visual display for each filtered annotation will be sequentially presented.

15. The method of claim 1, wherein the step of transforming the brain activity data corresponding to each filtered annotation in the set of filtered annotations into the visual display that is presented to the user comprises the step of enabling the user to define an additional temporal segment of the brain activity data before or after the filtered annotation to be included in the visual display.

16. The method of claim 1, wherein the step of transforming the brain activity data corresponding to each filtered annotation in the set of filtered annotations into the visual display comprises the step of simultaneously displaying a list of each filtered annotation in the set of filtered annotations, along with the visual display generated for the filtered annotation, the list highlighting a specific filtered annotation for which the visual display is currently being presented.

17. A computer-readable medium on which are stored machined readable and executable instructions, which when executed by a processor, implement a plurality of functions, including:
enabling a user to apply at least one filter to a plurality of annotations, each annotation corresponding to a different temporal segment from a plurality of temporal segments of brain activity data, thereby defining at least one filtered annotation, the set of filtered annotations being a subset of the plurality of annotations;
enabling a user to request a visual review of the set of filtered annotations; and
transforming the brain activity data corresponding to each filtered annotation in the set of filtered annotations into a visual display presented to the user.

18. A system for enabling a clinician to review brain activity data, comprising:
a viewing device upon which a visual display corresponding to brain activity data can be displayed;
a processor logically coupled to the viewing device; and
a memory logically coupled to the processor, the memory storing data and machine readable and executable instructions that when executed by the processor, cause a plurality of functions to be carried out, including:
filtering a plurality of annotations by enabling a user to select at least one criteria to be used to determine which of the plurality of annotations are to be included in a set of filtered annotations, the set of filtered annotations being a subset of the plurality of annotations;
enabling the user to request a visual review of the set of filtered annotations; and
transforming the brain activity data corresponding to each filtered annotation in the set of filtered annotations into a visual display that is visually presented to the user, on the viewing device.

19. The system of claim 18, wherein the plurality of annotations include annotations corresponding to a plurality of different categories and annotations that have descriptive parameters in addition to brain activity data, and wherein the machine readable and executable instructions, when executed by the processor, further cause the following functions to be carried out:
enabling the user to selectively include each annotation corresponding to a selected category in the set of filtered annotations; and
enabling the user to selectively include each annotation having a user-defined descriptive parameter in the set of filtered annotations.

20. A method for enabling a user to review brain activity data, comprising the steps of:
providing a plurality of annotations, each annotation including a temporal segment of brain activity collected from a patient, the plurality of annotations including:
annotations corresponding to a plurality of different categories; and
annotations that have descriptive parameters in addition to brain activity data;
filtering the plurality of annotations by enabling a user to select at least one criteria to be used to determine which of the plurality of annotations are to be included in a set of filtered annotations, the set of filtered annotations being a subset of the plurality of annotations, the step of enabling the user to select at least one criteria comprising the step of enabling the user to select at least one criteria from a group of criteria consisting of;
the plurality of different categories, each different category comprising a different criteria; and
a plurality of descriptive parameters, each different descriptive parameter comprising a different criteria;
enabling a user to request a visual review of the set of filtered annotations; and
transforming the brain activity data corresponding to each filtered annotation in the set of filtered annotations into a visual display that is presented to the user.
